(19) United States
(12) Patent Application Publication
(10) Pub. No.: US 2005/0186519 A1
(43) Pub. Date: Aug. 25, 2005

(54) Black-and-white thermographic material containing dye-forming chemistry

(75) Inventors: Joe E. Maskasky, Rochester, NY (US); Victor P. Scaccia, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/786,827

(22) Filed: Feb. 25, 2004

(51) Int. Cl. G03C 5/26

(52) U.S. Cl. 430/619

(57) ABSTRACT

Direct thermographic materials are designed to have image tone with near neutral density. Besides a non-photosensitive source of reducible silver ions, the materials also include a color developing agent precursor that releases a color developing agent when heated to a temperature of at least 80° C., and a combination of cyan and magenta dye-forming color couplers that provide cyan and magenta dyes. No black-and-white developers are purposely added to these materials. This combination of components provides a means for controlling image tone without reliance solely upon conventional toning agents that provide imaging toning only.

### FIELD OF THE INVENTION

This invention relates to black-and-white thermographic materials (“direct thermal” materials) that can provide images having improved tone from the incorporation of certain dye-forming chemistry. This invention also relates to methods of imaging using these thermographic materials.

### BACKGROUND OF THE INVENTION

Silver-containing thermographic imaging materials are non-photo-sensitive materials that are used in a recording process wherein images are generated by the direct application of thermal energy. These materials have been known in the art for many years and generally comprise a support having disposed thereon one or more imaging layers comprising (a) a relatively or completely non-photosensitive source of reducible silver ions, (b) a reducing composition (usually including a developer) for the reducible silver ions, and (c) a suitable hydrophilic or hydrophobic binder. Thermographic materials are sometimes called “direct thermal” materials in the art because they are directly imaged by a source of thermal energy without any transfer of the energy or image from another material.

In a typical thermographic construction, the image-forming layers are based on silver salts of long chain fatty acids. The preferred non-photosensitive reducible silver source is a silver salt of a long chain aliphatic carboxylic acid having from 10 to 30 carbon atoms, such as behenic acid or mixtures of acids of similar molecular weight. At elevated temperatures, the silver of the silver carboxylate is reduced by a reducing agent whereby a black-and-white image of elemental silver is formed.

### PROBLEM TO BE SOLVED

Thermographic materials are imaged by contacting them with the thermal head of a thermographic recording apparatus such as a thermal printer or thermal facsimile to form a visible image (usually a black-and-white image). Heat generated in the thermal print head can range from 100 to many hundreds of ° C. Because the contact between the thermal print head and a given area of the thermographic material is very short (a few milliseconds), the thermographic material never reaches the same temperature as the thermal print head.

It is difficult to generate a “neutral” black-and-white silver image in such materials due to the strong dependence of image tone on silver particle size and shape. Typically, the silver image tends to have a yellowish tint. Thus, fine balancing of toning agents (“toners”) and other components (such as reducing agents and development accelerators) is necessary to provide a desired “neutral” image tone but even then the image tone can change depending upon imaging conditions (that is, temperature and time). The use of toning agents to adjust image tone in thermally developable materials is a common practice as described in early literature such as U.S. Pat. No. 3,080,254 (Grant, Jr.), U.S. Pat. No. 3,847,612 (Winslow), and U.S. Pat. No. 4,123,282 (Winslow), and in more recent publications of which there are hundreds with U.S. Pat. No. 5,599,647 (Defieuw et al.) and U.S. Pat. No. 6,146,822 (Asanuma et al.) and EP 1,270,255 (Dooms et al.) being representative.

There is a need for better and more predictable control of image tone in thermographic materials that can be imaged under a variety of conditions.

### SUMMARY OF THE INVENTION

The present invention provides a black-and-white thermographic material comprising a support having thereon at least one imaging layer comprising a binder and imaging chemistry that consists essentially of:
a) a non-photosensitive source of reducible silver ions,
b) a color developing agent precursor that releases a color developing agent when heated to a temperature of at least 80° C.,
c) a cyan dye-forming color coupler that is capable of reacting with the released color developing agent to produce a cyan dye, and
d) a magenta dye-forming color coupler that is capable of reacting with the released color developing agent to produce a magenta dye,
wherein the released color developing agent is further capable of reducing the reducible silver ions.

In preferred embodiments of this invention, a black-and-white, non-photosensitive thermographic material that comprises a transparent polymer support having on only one side thereof one or more thermally sensitive imaging layers and an outermost non-thermally sensitive protective layer over the one or more thermally sensitive imaging layers,
the one or more thermally sensitive imaging layers comprising one or more hydrophilic binders, and in reactive association, imaging chemistry consisting essentially of:
a) a non-photosensitive source of reducible silver ions that includes one or more silver aliphatic carboxylates at least one of which is silver behenate,
b) a color developing agent precursor that releases apphenylenediamine color developing agent when heated to a temperature of at least 80° C.,
c) a development enhancing toning agent,
d) a cyan dye-forming color coupler that is capable of reacting with the released color developing agent to produce a cyan dye, and
e) a magenta dye-forming color coupler that is capable of reacting with the released color developing agent to produce a magenta dye,
the cyan dye-forming color coupler and magenta dye-forming color coupler being independently present in an amount from 0.1 to 1 mole per mole of reducible silver ions, and the amount of silver is at least 0.001 mol/m², and the material being substantially free of black-and-white developing agents that are capable of solely reducing the reducible silver ions.

In addition, this invention provides a method comprising imaging the thermographic material of the present invention with a thermal imaging source to provide a visible image.

The method of this invention can be used to provide an imaged thermographic material that is then used for medical diagnostic purposes.

When direct thermographic materials are imaged using thermal energy, the conventional components of reducing agent, non-photosensitive silver salt, and toning agents react to form a silver image that may not have the desired color tint or hue (or image tone). However, in the materials of this invention, the blocked color developing agent precursor and dye-forming color couplers provide a combination of cyan and magenta dyes in appropriate amounts so as to modify the tone of the resulting image. No conventional black-and-white developer or reducing agent is present (that is, compounds that are capable of solely reducing said reducible silver ions). Thus, the released color developing agent is capable of also reducing the reducible silver ions to provide appropriate yellow tint in balance with the cyan and magenta dyes. The resulting image is more nearly neutral in overall density, meaning that the overall red and green densities are closer to the blue density that inherently results from the silver metal. The overall density may be designed to be slightly “blue” in color (i.e., a lower blue density relative to the red and green densities) since users may prefer a bluish-black background for viewing the images.

Thus, the present invention provides a more convenient means for adjusting or controlling image tone without the need to use conventional toning agents of the type that significantly modify silver image tone. In the present invention, the yellow silver metal image tone is required for proper image tone balance with the magenta and cyan image dyes. However, development-enhancing toning agents used to accelerate development and improve silver development efficiency can be beneficial.

In preferred embodiments, the thermographic materials of this invention comprise a transparent support having thereon an aqueous-based imaging layer(s) comprising a hydrophilic binder such as gelatin or a gelatin derivative, and optionally an aqueous-based or solvent-based overcoat serving as a surface protective or “slip” layer. Thus, the preferred embodiments of this invention are coated out of aqueous-based formulations.

### DETAILED DESCRIPTION OF THE INVENTION

The direct thermographic materials of this invention can be used to provide black-and-white images using non-photosensitive silver salts, binders, and other components known to be useful in such materials, as well as the color developing agent precursors and dye-forming color couplers described herein. No black-and-white developers or compounds solely used to reduce the silver ions are purposely added to the materials. Thus, the concentration of such developers in the materials is generally less than 0.1 mol/mol of total silver.

The direct thermographic materials of this invention can be used in black-and-white thermography and in electronically generated black-and-white hardcopy recording. They can be used as output media, in radiographic imaging (for example digital medical imaging), X-ray radiography, and in industrial radiography. Furthermore, the absorbance of these thermographic materials between 350 and 450 nm is desirably low (less than 0.5), to permit their use in the graphic arts area (for example, in image-setting and phototypesetting operations), in the manufacture of printing plates, in contact printing, in duplicating (“duping”), and in proofing.

The direct thermographic materials of this invention are particularly useful as output media for medical imaging of human or animal subjects in response to thermal imaging means. Such applications include, but are not limited to, thoracic imaging, mammography, dental imaging, orthopedic imaging, general medical radiography, therapeutic radiography, veterinary radiography, and auto-radiography.

In the direct thermographic materials of this invention, the components needed for imaging can be in one or more thermally sensitive layers on one side (“frontside”) of the support. The layer(s) that contain the non-photosensitive source of reducible silver ions are referred to herein as thermo-graphic emulsion layer(s) or thermally sensitive imaging layer(s).

Where the materials contain thermographic imaging layers on one side of the support only, various non-imaging layers can be disposed on the “backside” (non-emulsion or non-imaging side) of the materials including an outermost slip layer and/or a conductive layer.

In such embodiments, various non-imaging layers can also be disposed on the “frontside,” imaging, or emulsion side of the support, including primer layers, interlayers, opacifying layers, subbing layers, carrier layers, antihalation layers, “slip” (or protective) layers, auxiliary layers, and other layers readily apparent to one skilled in the art.

For some embodiments, the direct thermographic materials may be “double-sided” or “duplitized” and have thermographic emulsion coating(s) or thermally sensitive imaging layer(s) on both sides of the support. In such constructions each side can also include one or more primer layers, interlayers, antistatic layers, auxiliary layers, conductive layers, “slip” (or protective) layers, and other layers readily apparent to one skilled in the art.

Definitions

As used herein:

In the descriptions of the thermographic materials of the present invention, “a” or “an” component refers to “at least one” of that component (for example, a color developing agent precursor or color coupler).

“Thermographic material(s)” means a construction comprising at least one thermographic emulsion layer or thermally sensitive imaging layer(s) wherein the source of reducible silver ions is in one layer and the other required components or optional additives are distributed, as desired, in the same layer or in an adjacent coated layers, as well as any supports, topcoat layers, image-receiving layers, carrier layers, blocking layers, conductive layers, antihalation layers, subbing or priming layers. These materials also include multilayer constructions in which one or more imaging components are in different layers, but are in “reactive association”. Thus, one layer can include the non-photosensitive source of reducible silver ions and another layer can include the color developing agent precursor, but the two reactive components are in reactive association with each other.

When used in thermography, the term, “imagewise exposing” or “imagewise exposure” means that the material is imaged using any means that provides an image using heat. This includes, for example, analog exposure where an image is formed by differential contact heating through a mask using a thermal blanket or infrared heat source, as well as by digital exposure where the image is formed one pixel at a time such as by modulation of thermal print-heads or laser imaging sources.

The materials of this invention are “direct” thermographic materials used in “direct thermal transfer” in which imaging is either “on” or “off” (bimodal), and thermal imaging is carried out in a single “element” containing all of the necessary imaging chemistry. Direct thermal imaging is distinguishable from what is known in the art as thermal transfer imaging (such as dye transfer imaging) in which the image is produced in one element (“donor”) and transferred to another element (“receiver”) using thermal means.

“Catalytic proximity” or “reactive association” means that the components are in the same layer or in adjacent layers so that they readily come into contact with each other during thermal imaging and development.

“Emulsion layer,” “imaging layer,” or “thermographic emulsion layer,” means a thermally sensitive layer of a thermographic material that contains the non-photosensitive source of reducible silver ions. It can also mean a layer of the thermographic material that contains, in addition to the non-photosensitive source of reducible ions, additional required components or optional additives. These layers are usually on what is known as the “frontside” of the support.

The slip layer is generally the outermost layer on the imaging side of the material that is in direct contact with the imaging means.

Many of the chemical components used herein are provided as a solution. The term “active ingredient” means the amount or the percentage of the desired material contained in a sample. All amounts listed herein are the amount of active ingredient added unless otherwise specified.

“Ultraviolet region of the spectrum” refers to that region of the spectrum less than or equal to 410 nm, and preferably from about 100 nm to about 410 nm. “visible region of the spectrum” refers to that region of the spectrum of from about 400 nm to about 700 nm. “Infrared region of the spectrum” refers to that region of the spectrum of from about 700 nm to about 1400 nm.

“Non-photosensitive” means not intentionally light sensitive. The direct thermographic materials of the present invention are non-photosensitive meaning that no photosensitive silver halide(s) has been purposely added.

The sensitometric terms, absorbance, contrast, Dₘᵢₙ, and Dₘₐₓ have conventional definitions known in the imaging arts. In thermographic materials, Dₘᵢₙ is considered herein as image density in the non-thermally imaged areas of the thermographic material. The sensitometric term absorbance is another term for optical density (OD).

“Transparent” means capable of transmitting visible light or imaging radiation without appreciable scattering or absorption.

As used herein, the phrase “silver organic coordinating ligand” refers to an organic molecule capable of forming a bond with a silver atom. Although the compounds so formed are technically silver coordination compounds they are also often referred to as silver salts.

The terms “double-sided”, “double-faced coating”, or “duplitized” are used to define thermographic materials having one or more of the same or different imaging layers disposed on both sides (front and back) of the support.

As a means of simplifying the discussion and recitation of certain substituent groups, the term “group” refers to chemical species that may be substituted as well as those that are not so substituted. Thus, the term “alkyl group” is intended to include not only pure hydrocarbon alkyl chains, such as methyl, ethyl, n-propyl, t-butyl, cyclohexyl, iso-octyl, and octadecyl, but also alkyl chains bearing substituents known in the art, such as hydroxyl, alkoxy, phenyl, halogen atoms (F, Cl, Br, and I), cyano, nitro, amino, and carboxy. Also, an alkyl group can include ether and thioether groups (for example CH₃—CH₂—CH₂—O—CH₂— and CH₃—CH₂—CH₂—S—CH₂—), haloalkyl, nitroalkyl, alkylcarboxy, carboxyalkyl, carboxamido, hydroxyalkyl, sulfoalkyl, and other groups readily apparent to one skilled in the art.

Research Disclosure is a publication of Kenneth Mason Publications Ltd., Dudley House, 12 North Street, Emsworth, Hampshire PO10 7DQ England. It is also available from Emsworth Design Inc., 147 West 24th Street, New York, N.Y. 10011.

Other aspects, advantages, and benefits of the present invention are apparent from the detailed description, examples, and claims provided in this application.

Non-Photosensitive Source of Reducible Silver Ions

The non-photosensitive source of reducible silver ions used in the direct thermographic materials of this invention can be any silver-organic compound that contains reducible silver (1+) ions. Such compounds are generally silver salts of silver organic coordinating ligands. Preferably, it is an organic silver salt that is comparatively stable to light and forms a silver image when heated to 50° C. or higher in the presence of a compound that will reduce the silver ions to silver.

Silver salts of organic acids including silver salts of long-chain carboxylic acids are preferred. The chains typically contain 10 to 30, and preferably 15 to 28, carbon atoms. Useful silver salts include a silver salt of an aliphatic carboxylic acid or a silver salt of an aromatic carboxylic acid (such as benzoates). Preferred examples of the silver salts of aliphatic carboxylic acids include silver behenate, silver arachidate, silver stearate, silver oleate, silver laurate, silver caprate, silver myristate, silver palmitate, silver maleate, silver fumarate, silver tartarate, silver furoate, silver linoleate, silver butyrate, silver camphorate, and mixtures thereof. Preferably, at least silver behenate is used alone or in mixtures with other silver salts.

In some embodiments, a highly crystalline silver behenate can be used as part or all of the non-photosensitive sources of reducible silver ions, as described in U.S. Pat. No. 6,096,486 (Emmers et al.) and U.S. Pat. No. 6,159,667 (Emmers et al.), both incorporated herein by reference. Moreover, the silver behenate can be used in its one or more crystallographic phases (such as a mixture of phases I, II and/or III) as described for example in EP 1 158 355A1 (Geuens et al.), incorporated herein by reference.

Other useful but less preferred silver salts include but are not limited to, silver salts of aromatic carboxylic acid and other carboxylic acid group-containing compounds, silver salts of aliphatic carboxylic acids containing a thioether group as described in U.S. Pat. No. 3,330,663 (Weyde et al.), silver carboxylates comprising hydrocarbon chains incorporating ether or thioether linkages, or sterically hindered substitution in the α- (on a hydrocarbon group) or ortho- (on an aromatic group) position, as described in U.S. Pat. No. 5,491,059 (Whitcomb), silver salts of aliphatic, aromatic, or heterocyclic dicarboxylic acids, silver salts of sulfonates as described in U.S. Pat. No. 4,504,575 (Lee), silver salts of sulfosuccinates as described in EP 0 227 141 A1 (Leenders et al.), silver salts of acetylenes as described in U.S. Pat. No. 4,761,361 (Ozaki et al.) and U.S. Pat. No. 4,775,613 (Hirai et al.), silver salts of compounds containing mercapto or thione groups and derivatives thereof (such as those having a heterocyclic nucleus containing 5 or 6 atoms in the ring, at least one of which is a nitrogen atom), as described in U.S. Pat. No. 4,123,274 (Knight et al.) and U.S. Pat. No. 3,785,830 (Sullivan et al.), silver salts of mercapto or thione substituted compounds that do not contain a heterocyclic nucleus, silver salts of compounds containing an imino group (such as silver salts of benzotriazole and substituted derivatives thereof), silver salts of 1,2,4-triazoles or 1-H-tetrazoles as described in U.S. Pat. No. 4,220,709 (deMauriac), and silver salts of imidazoles and imidazole derivatives as described in U.S. Pat. No. 4,260,677 (Winslow et al.), silver triazolates, silver sulfonates, silver sulfosuccinates, and silver acetylides.

The methods used for making silver soap emulsions are well known in the art and are disclosed in Research Disclosure, April 1983, item 22812, Research Disclosure, October 1983, item 23419, U.S. Pat. No. 3,985,565 (Gabrielsen et al.), and the references cited above.

Non-photosensitive sources of reducible silver ions can also be provided as core-shell silver salts such as those described in U.S. Pat. No. 6,355,408 (Whitcomb et al.), that is incorporated herein by reference, or as silver dimer compounds that comprise two different silver salts as described in U.S. Pat. No. 6,472,131 (Whitcomb), that is also incorporated herein by reference.

Still other useful sources of non-photosensitive reducible silver ions in the practice of this invention are the silver core-shell compounds comprising a primary core comprising one or more photosensitive silver halides, or one or more non-photosensitive inorganic metal salts or non-silver containing organic salts, and a shell at least partially covering the primary core, wherein the shell comprises one or more non-photosensitive silver salts, each of which silver salts comprises a organic silver coordinating ligand. Such compounds are described in copending and commonly assigned U.S. Ser. No. 10/208,603 (filed Jul. 30, 2002 by Bokhonov, Burleva, Whitcomb, Howlader, and Leichter) that is incorporated herein by reference.

The non-photosensitive source of reducible silver ions can also be provided in the form of an aqueous nanoparticulate dispersion of silver salt particles (such as silver carboxylate particles). The silver salt particles in such dispersions generally have a weight average particle size of less than 1000 nm when measured by any useful technique such as sedimentation field flow fractionation, photon correlation spectroscopy, or disk centrifugation. Obtaining such small silver salt particles can be achieved using a variety of techniques but generally they are achieved using high-speed milling using a device such as those manufactured by Morehouse-Cowles and Hochmeyer. The details for such milling are well known in the art.

Such dispersions also advantageously include a surface modifier so the silver salt can more readily be incorporated into aqueous-based photothermographic formulations. Useful surface modifiers include, but are not limited to, vinyl polymers having an amino moiety, such as polymers prepared from acrylamide, methacrylamide, or derivatives thereof, as described in U.S. Pat. No. 6,391,537 (Lelental et al.), incorporated herein by reference. A particularly useful surface modifier is dodecylthiopolyacrylamide that can be prepared as described in the noted copending application using the teaching provided by Pavia et al., Makromoleculare Chemie, 193(9), 1992, pp. 2505-17.

Other useful surface modifiers are phosphoric acid esters, such as mixtures of mono- and diesters of orthophosphoric acid and hydroxy-terminated, oxyethylated long-chain alcohols or oxyethylated alkyl phenols as described for example in U.S. Pat. No. 6,387,611 (Lelental et al.), incorporated herein by reference. Particularly useful phosphoric acid esters are commercially available from several manufacturers under the trademarks or tradenames EMPHOS™ (Witco Corp.), RHODAFAC (Rhone-Poulenc), T-MULZ® (Hacros Organics), and TRYFAC (Henkel Corp./Emery Group).

Such dispersions contain smaller particles and narrower particle size distributions than dispersions that lack such surface modifiers. Particularly useful nanoparticulate dispersions are those comprising silver carboxylates such as silver behenate. These nanoparticulate dispersions can be used in combination with the conventional silver salts described above including silver benzotriazole.

The one or more non-photosensitive sources of reducible silver ions are preferably present in an amount of from about 5% to about 70% (more preferably from about 10% to about 50%), based on the total dry weight of the emulsion layers. Stated another way, the amount of the sources of reducible silver ions is generally present in an amount of from about 0.001 to about 0.2 mol/m² of the thermographic material (preferably from about 0.002 to about 0.02 mol/m²).

Color Developing Agent Precursors and Dye-Forming Color Couplers

The present invention uses one or more color developing agent precursors in the thermographic materials. By “precursor” is meant that the compounds are capable of releasing a compound that is a color developing agent when heated to a temperature of at least 80° C. Such precursor compounds may also be described as “blocked” color developing agents that become “unblocked” or reactive upon heating to the appropriate temperature. The released color developing agents can be any of those known in the art for providing color images in color photographic materials including but not limited to, aminophenols, p-phenylenediamines (especially N,N-dialkyl-p-phenylenediamines) and others which are well known in the art, such those described in EP 0 434 097A1 (published Jun. 26, 1991) and EP 0 530 921A1 (published Mar. 10, 1993). It may be useful for the released color developing agents to have one or more water-solubilizing groups as are known in the art. Further details of such materials are provided in Research Disclosure, publication 38957, pages 592-639 (September 1996). The color developing agent precursors then have an appropriate “blocking” group that prohibits there reaction with a dye-forming color coupler until the color developing agent is released during thermal imaging. Useful blocking groups would be readily apparent to one skilled in the art.

Representative color developing agent precursors are described in several publications including U.S. Patent Publication 2002/0018967 (Irving et al.), incorporated herein by reference for the compounds described in paragraphs 0143 through 0228 including the specific compounds identified as D-1 through D-46. Such compounds can be prepared using known procedures and starting materials as described in the art including the noted patent publication.

Particularly useful color developing agent precursors are identified below for use in the examples as CDA-1, CDA-2, CDA-3, CDA-4, and CDA-5.

The one or more color developing agent precursors are present in an amount of from about 0.01 to about 2 mol per mole of total silver.

The photothermographic materials of this invention also include a combination of one or more magenta dye-forming color couplers and one or more cyan dye-forming color couplers to provide the desired neutral images described herein. Any convenient cyan and magenta dye-forming color couplers can be employed as would be determined by a skilled worker in the art through routine experimentation to determine how much of what color couplers would improve the image tone. In general, the amount of such dye-forming couplers is from 0.05 to 2 mol, and preferably from 0.1 to 1 mol, per mole of reducible silver ions, independently for the cyan dye-forming color couplers and the magenta dye-forming color couplers.

Conventional dye forming couplers are described in considerable publications too numerous to mention including Research Disclosure, Number 389, Item 38957, Section X. Dye image formers and modifiers, B. Image-dye-forming couplers, publications noted therein. Representative cyan dye-forming color couplers are described in U.S. Pat. No. 5,453,348 (Kuse et al.). Examples of useful cyan dye-forming color couplers include compounds having a naphthol or phenol structure and that form indoaniline dyes via the coupling reaction with a color developing agent. Representative examples of magenta dye-forming color couplers include compounds having a 5-pyrazolone ring with an active methylene group and pyrazoloazole compounds. Both 2-equivalent and 4-equivalent dye-forming color couplers can be used.

Particularly useful dye-forming color couplers are identified below for the Examples as C-1 (cyan), C-2 (cyan), and M-1 (magenta).

Other Addenda

The direct thermographic materials of this invention can also contain other additives such as toning agents, shelf-life stabilizers, contrast enhancers, dyes or pigments, post-processing stabilizers or stabilizer precursors, thermal solvents (also known as melt formers), and other image-modifying or development-modifying agents as would be readily apparent to one skilled in the art.

Suitable stabilizers that can be used alone or in combination include thiazolium salts as described in U.S. Pat. No. 2,131,038 (Staud) and U.S. Pat. No. 2,694,716 (Allen), azaindenes as described in U.S. Pat. No. 2,886,437 (Piper), triazaindolizines as described in U.S. Pat. No. 2,444,605 (Heimbach), the urazoles as described in U.S. Pat. No. 3,287,135 (Anderson), sulfocatechols as described in U.S. Pat. No. 3,235,652 (Kennard), oximes as described in GB 623,448 (Carrol et al.), polyvalent metal salts as described in U.S. Pat. No. 2,839,405 (Jones), thiuronium salts as described in U.S. Pat. No. 3,220,839 (Herz), palladium, platinum, and gold salts as described in U.S. Pat. No. 2,566,263 (Trirelli) and U.S. Pat. No. 2,597,915 (Damshroder), compounds having —SO₂CBr₃ groups as described for example in U.S. Pat. No. 5,594,143 (Kirk et al.) and U.S. Pat. No. 5,374,514 (Kirk et al.), and 2-(tribromomethylsulfonyl)quinoline compounds as described in U.S. Pat. No. 5,460,938 (Kirk et al.).

Stabilizer precursor compounds capable of releasing stabilizers upon application of heat during imaging can also be used. Such precursor compounds are described in for example, U.S. Pat. No. 5,158,866 (Simpson et al.), U.S. Pat. No. 5,175,081 (Krepski et al.), U.S. Pat. No. 5,298,390 (Sakizadeh et al.), and U.S. Pat. No. 5,300,420 (Kenney et al.).

In addition, certain substituted-sulfonyl derivatives of benzo-triazoles may be used as stabilizing compounds as described in U.S. Pat. No. 6,171,767 (Kong et al.) and U.S. Pat. No. 6,083,681 (Lynch et al.).

The direct thermographic materials of this invention may also include one or more thermal solvents (or melt formers) as disclosed in U.S. Pat. No. 3,438,776 (Yudelson), U.S. Pat. No. 5,250,386 (Aono et al.), U.S. Pat. No. 5,368,979 (Freedman et al.), U.S. Pat. No. 5,716,772 (Taguchi et al.), and U.S. Pat. No. 6,013,420 (Windender). Toning agents (also referred to as “toners”) can modify a thermographic material is several ways: (1) increasing image density for a given amount of coated silver, (2) improving the rate of development thereby reducing processing time, and (3) shifting the color of the image from yellowish-orange to brown-black or blue-black. Since the present invention uses other components to improve image tone and relies on the yellow image tone of the image silver metal, toning agents that only result in a color shift are not required in this invention and if they are highly effective in shifting the silver image tone, they would be undesirable at such a working level but lower levels could be useful. Phthalazinone and phthalazinone derivatives (or metal salts thereof) would not be useful in the practice of this invention. Thus, the materials are substantially free of such compounds (that is, they are present at less than 0.0002 mol/m²).

However, “toning agents” that increase image density and improve development rate only are highly desirable. Unfortunately compounds known to do one or more of these three functions are often collectively referred to as toning agents. The one or more toning agents may be present in an amount of from about 0.01% to about 10% (more preferably from about 0.1% to about 10%), based on the total dry weight of the layer in which it is included. Toning agents may be incorporated in any imaging or non-imaging layer.

Toning agents are well known materials in the art, as shown in U.S. Pat. No. 3,080,254 (Grant, Jr.), U.S. Pat. No. 3,847,612 (Winslow), U.S. Pat. No. 4,123,282 (Winslow), U.S. Pat. No. 4,082,901 (Laridon et al.), U.S. Pat. No. 3,074,809 (Owen), U.S. Pat. No. 3,446,648 (Workman), U.S. Pat. No. 3,844,797 (Willems et al.), U.S. Pat. No. 3,951,660 (Hagemann et al.), and U.S. Pat. No. 5,599,647 (Defieuw et al.) and in GB 1,439,478 (AGFA).

Examples of toning agents include phthalimide and N-hydroxyphthalimide, cyclic imides, pyrazoline-5-ones, quinazolinone, 1-phenylurazole, 3-phenyl-2-pyrazoline-5-one, and 2,4-thiazolidinedione, naphthalimides, cobalt complexes, mercaptans, N-(aminomethyl)aryl-dicarboximides, a combination of blocked pyrazoles, isothiuronium derivatives, and certain photobleach agents, merocyanine dyes, phthalazine and derivatives thereof [such as those described in U.S. Pat. No. 6,146,822 (Asanuma et al.)], a combination of phthalazine (or derivative thereof) plus one or more phthalic acid derivatives, quinazolinediones, benzoxazine or naphthoxazine derivatives, rhodium complexes functioning not only as tone modifiers but also as sources of halide ion for silver halide formation in-situ, benzoxazine-2,4-diones and naphthoxazine diones as described in U.S. Pat. No. 5,817,598 (noted above), pyrimidines, asym-triazines, and tetraazapentalene derivatives.

Also useful are the phthalazine compounds described in copending and commonly assigned U.S. Ser. No. 10/281,525 (filed Oct. 28, 2002 by Ramsden and Zou), the triazine thione compounds described in copending and commonly assigned U.S. Ser. No. 10/341,754 (filed Jan. 14, 2003 by Lynch, Ulrich, and Skoug), and the heterocyclic disulfide compounds described in copending and commonly assigned U.S. Ser. No. 10/384,244 (filed Mar. 7, 2003 by Lynch and Ulrich), all of which are incorporated herein by reference.

The thermographic materials may also include one or more polycarboxylic acids and/or anhydrides thereof that are in thermal working relationship with the sources of reducible silver ions. Such polycarboxylic acids can be substituted or unsubstituted aliphatic or aromatic compounds. They can be used in anhydride or partially esterified form as long as two free carboxylic acids remain in the molecule. Useful polycarboxylic acids are described for example in U.S. Pat. No. 6,096,486 (noted above).

Binders

The non-photosensitive source of reducible silver ions, color developing agent precursor, dye-forming color couplers, and any optional additives used in the present invention are generally mixed with one or more binders to form a coating formulation.

In some embodiments, the binders are predominantly (at least 50% by weight of total binders) hydrophilic in nature and aqueous solvent-based formulations are used to prepare such thermographic materials. Mixtures of hydrophilic binders can also be used.

Examples of useful hydrophilic binders that can be used include proteins and protein derivatives, gelatin and gelatin-like derivatives (hardened or unhardened), cellulosic materials, acrylamide/methacrylamide polymers, acrylic/methacrylic polymers polyvinyl pyrrolidones, polyvinyl alcohols, poly(vinyl lactams), polymers of sulfoalkyl acrylate or methacrylates, hydrolyzed polyvinyl acetates, polyacrylamides, polysaccharides, and other synthetic or naturally occurring vehicles commonly known for use in aqueous-based imaging emulsions.

Water-dispersible binders including water-dispersible polymer latexes can also be used for some or all of the hydrophilic binders in the thermographic materials of this invention. Such materials are well known in the art including U.S. Pat. No. 6,096,486 (noted above).

In other embodiments, the binders are predominantly (at least 50 weight % of total binder weight) hydrophobic in nature and organic-solvents formulations are used to prepare such thermographic materials. Examples of useful hydrophobic binders include polyvinyl acetals, polyvinyl chloride, polyvinyl acetate, cellulose acetate, cellulose acetate butyrate, polyolefins, polyesters, polystyrenes, polyacrylonitrile, polycarbonates, methacrylate copolymers, maleic anhydride ester copolymers, butadiene-styrene copolymers, and other materials readily apparent to one skilled in the art. Copolymers (including terpolymers) are also included in the definition of polymers. The polyvinyl acetals (such as polyvinyl butyral and polyvinyl formal), cellulose ester polymers, and vinyl copolymers (such as polyvinyl acetate and polyvinyl chloride) are preferred. Particularly suitable binders are polyvinyl butyral resins that are available as BUTVAR® B79 (Solutia, Inc.) and PIOLOFORM® BS-18 or PIOLOFORM® BL-16 (Wacker Chemical Company) and cellulose ester polymers.

The polymer binder(s) is used in an amount sufficient to carry the components dispersed therein. Generally, one or more binders are used at a level of about 10% by weight to about 90% by weight (more preferably at a level of about 20% by weight to about 70% by weight) based on the total dry weight of the layer in which it is included.

Support Materials

The thermographic materials of this invention comprise a polymeric support that is preferably a flexible, transparent film that has any desired thickness and is composed of one or more polymeric materials, depending upon their use. The supports are generally transparent (especially if the material is used as a photomask) or at least translucent, but in some instances, opaque supports may be useful. They are required to exhibit dimensional stability during thermal imaging and development and to have suitable adhesive properties with overlying layers. Useful polymeric materials for making such supports include polyesters, cellulose acetate and other cellulose esters, polyvinyl acetal, polyolefins, polycarbonates, and polystyrenes. Preferred supports are composed of polyesters and polycarbonates.

Support materials can contain various colorants, pigments, and antihalation or acutance dyes if desired. For example, the support can contain conventional blue dyes that differ in absorbance from colorants in the various frontside or backside layers as described in U.S. Pat. No. 6,248,442 (Van Achere et al.). Support materials may be treated using conventional procedures (such as corona discharge) to improve adhesion of overlying layers, or subbing or other adhesion-promoting layers can be used, or treated or annealed to promote dimensional stability.

The thermographic materials preferably have an outermost slip or protective layer on at least the imaging side of the support comprising useful components such as one or more specific lubricants and/or matting agents that are known in the art. The matting agents can be composed of any useful material and may have a size in relation to the slip layer thickness that enables them to protrude through the outer surface of the conductive layer, as described for example, in U.S. Pat. No. 5,536,696 (Horsten et al.). Particularly useful combinations of lubricants are described in copending and commonly assigned U.S. Ser. No. 10/767,757 (filed on Jan. 28, 2004 by Kenney, Foster, and Johnson) that is incorporated herein by reference.

Thermographic Formulations

An organic-based formulation for the thermographic emulsion layer(s) can be prepared by dissolving and dispersing the binder, the source of non-photosensitive silver ions, color developing agent precursor, dye-forming color couplers, and optional addenda in an organic solvent, such as toluene, 2-butanone (methyl ethyl ketone), acetone, or tetrahydrofuran (or mixtures thereof). If an aqueous-based formulation is used for the preferred embodiments, a similar dispersion is made in an aqueous solvent that comprises at least 50 volume % water. Some of the components may not be water-soluble and thus may need to be dispersed in organic solvents that are miscible with the solvent used to make the formulation.

The thermographic materials of this invention can be constructed of two or more layers on the imaging side of the support. Two-layer materials would include a single imaging layer and an outermost protective layer. The single imaging layer would contain all of the components needed for imaging, those components desired for the present invention, as well as optional materials such as toning agents, development accelerators, thermal solvents, coating aids, and other additives.

Layers or polymeric materials to promote adhesion in thermo-graphic materials are described for example in U.S. Pat. No. 5,891,610 (Bauer et al.), U.S. Pat. No. 5,804,365 (Bauer et al.), U.S. Pat. No. 4,741,992 (Przezdziecki), and U.S. Pat. No. 5,928,857 (Geisler et al.).

Layers to reduce emissions from the film may also be present as described in U.S. Pat. No. 6,352,819 (Kenney et al.), U.S. Pat. No. 6,352,820 (Bauer et al.), and U.S. Pat. No. 6,420,102 (Bauer et al.), and in copending and commonly assigned U.S. Ser. No. 10/351,814 (filed Jan. 27, 2003 by Hunt), all incorporated herein by reference.

Layer formulations described herein can be coated by various coating procedures including wire wound rod coating, dip coating, air knife coating, curtain coating, slide coating, or extrusion coating. The formulations can be coated one at a time, or two or more formulations can be coated simultaneously by the procedures described in the art.

When the layers are coated simultaneously using various coating techniques, a “carrier” layer formulation comprising a single-phase mixture of the two or more polymers described above may be used as described in U.S. Pat. No. 6,436,622 (Geisler), incorporated herein by reference.

Preferably, two or more layers are applied to a film support using slide coating with the first layer coated on top of the second layer while the second layer is still wet using the same or different solvents (or solvent mixtures).

While the first and second layers can be coated on one side of the film support, manufacturing methods can also include forming one or more layers on the opposing or backside of said polymeric support.

Preferred embodiments include a conductive layer on one or both sides of the support, and more preferably on the backside of the support. Various conductive materials are known in the art such as soluble salts, evaporated metal layers, or ionic polymers as described in U.S. Pat. No. 2,861,056 (Minsk) and U.S. Pat. No. 3,206,312 (Sterman et al.), insoluble inorganic salts as described in U.S. Pat. No. 3,428,451 (Trevoy), electroconductive underlayers as described in U.S. Pat. No. 5,310,640 (Markin et al.), and electrically-conductive metal-containing particles dispersed in a polymeric binder as described in EP 0 678 776A1 (Melpolder et al.). In addition, fluorochemicals such as Fluorad® FC-135 (3M Corporation), ZONYL® FSN (E. I. DuPont de Nemours & Co.), as well as those described in U.S. Pat. No. 5,674,671 (Brandon et al.), U.S. Pat. No. 6,287,754 (Melpolder et al.), U.S. Pat. No. 4,975,363 (Cavallo et al.), U.S. Pat. No. 6,171,707 (Gomez et al.), and in copending and commonly assigned U.S. Ser. No. 10/107,551 (filed Mar. 27, 2002 by Sakizadeh, LaBelle, Orem, and Bhave) and Ser. No. 10/265,058 (filed Oct. 10, 2002 by Sakizadeh, LaBelle, and Bhave) can be used.

In preferred embodiments, the conductive layer includes one or more specific non-acicular metal antimonate particles such as non-acicular metal antimonate particles composed of ZnSb₂O₆.

Imaging/Development

The direct thermographic materials of the present invention can be imaged in any suitable manner consistent with the type of material using any suitable source of thermal energy. The image may be “written” simultaneously with development at a suitable temperature using a thermal stylus, a thermal print head, or a laser, or by heating while in contact with a heat-absorbing material. The thermographic materials may include a dye (such as an IR-absorbing dye) to facilitate direct development by exposure to laser radiation.

Use as a Photomask

The direct thermographic materials of the present invention are sufficiently transmissive in the range of from about 350 to about 450 nm in non-imaged areas to allow their use in a method where there is a subsequent exposure of an ultraviolet or short wavelength visible radiation sensitive imageable medium. The materials may then be used as a mask and positioned between a source of imaging radiation (such as an ultraviolet or short wavelength visible radiation energy source) and an imageable material that is sensitive to such imaging radiation, such as a photopolymer, diazo material, photoresist, or photosensitive printing plate.

In such embodiments, the imaging method of this invention can further comprise:
positioning the imaged thermographic material with the visible image thereon between a source of imaging radiation and an imageable material that is sensitive to the imaging radiation, and
thereafter exposing said imageable material to the imaging radiation through the visible image in the imaged thermographic material to provide an image in the imageable material.

The following examples are provided to illustrate the practice of the present invention and the invention is not meant to be limited thereby.

### MATERIALS AND METHODS FOR THE EXAMPLES

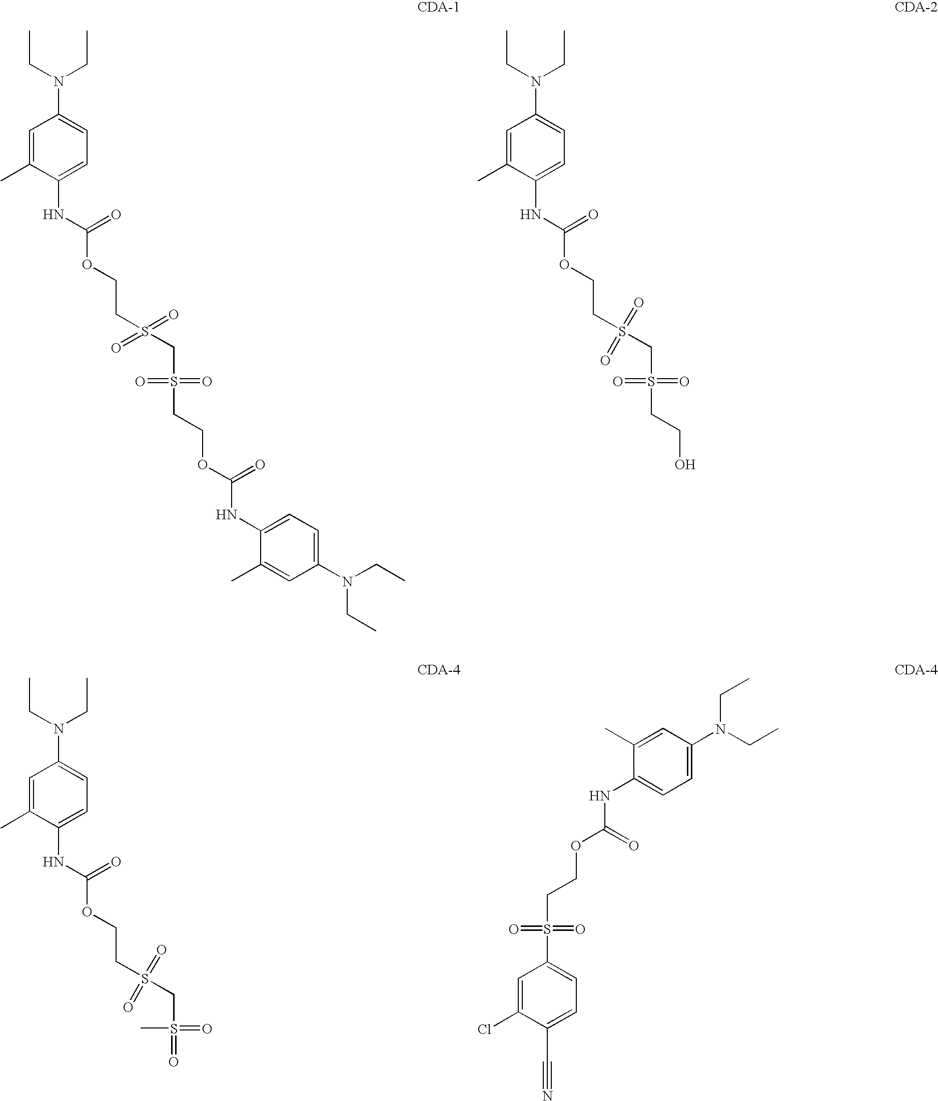

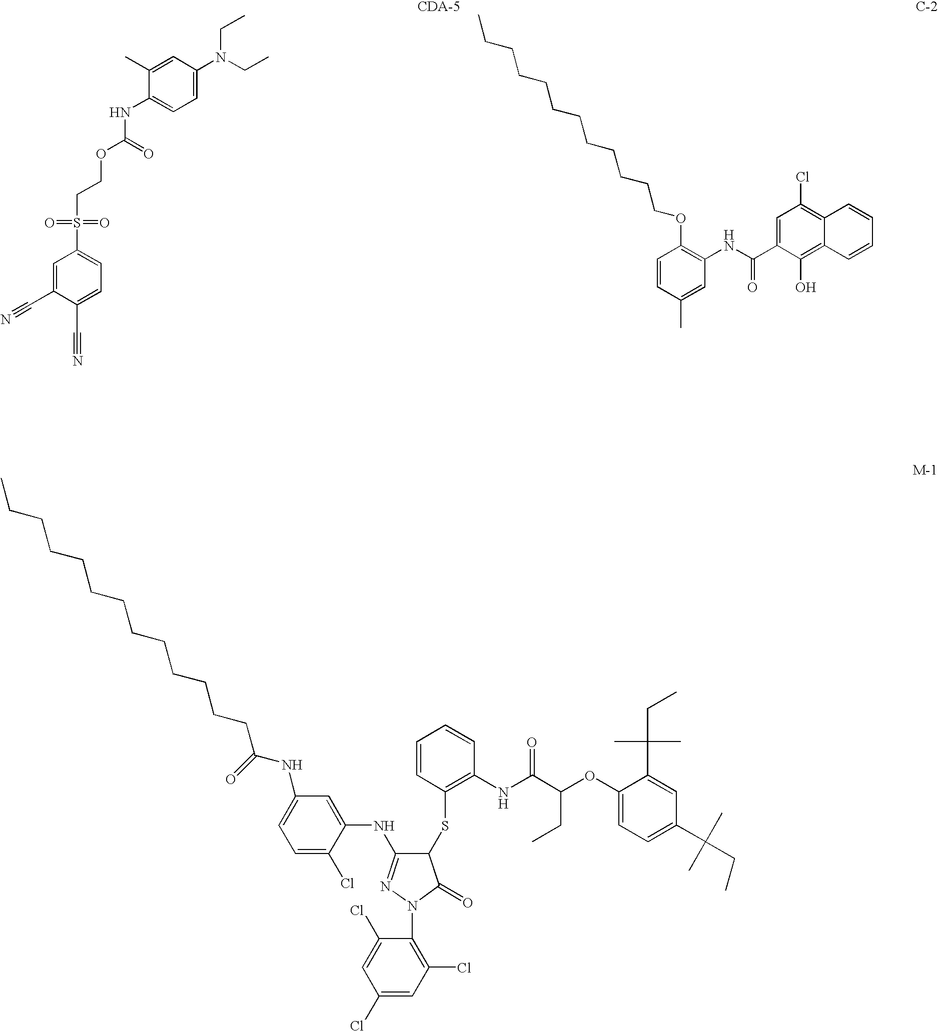

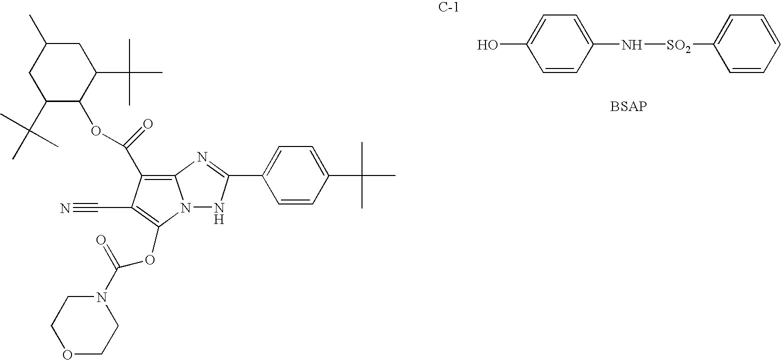

Cyan-1 Coupler Dispersion:

A cyan dye forming coupler dispersion was prepared containing 5 weight % of C-1, 5 weight % of tri(methylphenyl)phosphate (KS 1) coupler solvent, and 6 weight % of gelatin using conventional techniques.

Magenta-1 Coupler Dispersion:

A magenta dye forming coupler dispersion was prepared containing 6.8 weight % of M-1, 6.8 weight % of KS1 coupler solvent, and 7.8 weight % of gelatin using conventional techniques.

Color Developing Agent Precursor Dispersion (Dispersion-1):

A solid particle dispersion of color developing agent precursor was prepared containing 13.2 weight % of CDA-1 and 4 weight % of gelatin.

Color Developing Agent Precursor Dispersion (Dispersion-3):

A solid particle dispersion of color developing agent precursor was prepared containing 9.36 weight % of CDA-3 and 0.36 weight % of Olin 10G surfactant.

KODAK Color Developing Agent CD-2 (“CD-2”) is N,N-diethyl-2-methyl-p-phenylenediamine monohydrochloride, and KODAK Color Developing Agent CD-3 (“CD-3”) is 4-(N-ethyl-N-2-methanesulfonylaminoethyl)-2-methylphenylenediamine 1.5-H₂SO₄, monohydrate.

HAR1 Hardener Solution:

A hardener composition was prepared containing 2.7 weight % of bis(vinylsulfonyl)methane (BVSM).

Black-and-White Reducing Agent Dispersion (BWDev):

A solid particle dispersion of BSAP identified above was prepared by milling a 20% solution of BSAP with 1.6 weight % of poly(vinyl pyrrolidone) and 0.8 weight % of sodium dodecyl sulfate (SDS) surfactant in water. The final reducing agent (BSAP) concentration was 18.4 weight %.

Silver Behenate-Phthalazine Complex Dispersion (DISP-1):

A dispersion (DISP-1) of a silver behenate-phthalazine complex was prepared as follows:

A 20-gallon (75.7-liter) reactor was charged with 31.5 kg of water, 135 g of ML-4141 surfactant (described in U.S. Patent Publication 2001-0031436 A1), 4.05 g of 1-dodecanethiol, and 925.6 g of behenic acid (nominally 90% behenic acid recrystallized from isopropanol to purify). The reaction contents were stirred at 150 RPM with a retreat curve stirrer and heated to 70° C. Once the mixture reached 70° C., 1243.6 g of 10.81% aqueous potassium hydroxide and 26.2 g of phthalazine were added to the reactor. The resulting mixture was heated to 80° C. and held there for 30 minutes. The reaction mixture was then cooled to 70° C. When the reactor reached 70° C., 3125 g of 12.77% aqueous silver nitrate were added to the reactor in over 5 minutes. After this addition, the resulting nanoparticulate silver behenate-phthalazine complex compound combination was held at the reaction temperature for 30 minutes and then cooled to room temperature and filtered. A dispersion of a silver (behenate-phthalazine) complex compound having a median particle size of 160 nm was obtained.

A 37.5 kg portion of a 3% solids nanoparticulate silver (behenate-phthalazine) particle dispersion was loaded into the hopper of a conventional diafiltration/ultrafiltration apparatus. The permeator membrane cartridge was an Osmonics model 23-20k-PS-S8J that has an effective surface area of 13 ft² (1.2 m 2) and a nominal molecular weight cutoff of 20,000. The permeate was replaced with deionized water until 112 kg of permeate had been removed from the dispersion. At this point, the replacement water was turned off and the apparatus was run until the dispersion had been concentrated to 28% solids. The yield was 3200 grams and had a silver content of 56.6 g/l and a silver behenate content of 235 g/l.

Silver Behenate Dispersion (DISP-2):

A dispersion (DISP-2) of silver behenate was prepared like DISP-1 except phthalazine was not included in the reaction mixture during the precipitation.

The color densities, both before and after processing are shown in TABLES I and II provided below. The red, green, and blue densities were measured using Status A densitometry having spectral measuring peaks at 450 nm (for blue density), 550 nm (for green density), and 625 nm (for red density), respectively, using a Macbeth TD504 densitometer and the appropriate filters (see T. H. James, The Theory of the Photographic Process, 4^{th} Ed., Macmillan Publishing Co., Inc., N.Y., 1977, page 521 for details of this process. Also shown are the average densities of the three color densities and the “spread” that is the maximum difference between the highest and lowest measured color densities for each film even though it may be desirable to have a little higher blue density since medical professionals generally prefer to view images in bluish films. It is desired that the red, green, and blue densities be close to each other. It is also desired that the three color densities are as high as possible and that the “spread” be as low as possible for a given coverage of reducible silver ions.

### EXAMPLE 1 (INVENTION)

A direct thermographic material of the present invention was prepared in the following manner:

To a stirred solution of 11 g of deionized water and 0.66 g of oxidized deionized bone gelatin at 40° C. were added 1.47 g of DISP-1, 2.54 g of Cyan-1 Coupler Dispersion, 1.18 g of Magenta-1 Coupler Dispersion, and 0.15 ml of 6.8 weight % surfactant solution. The resulting mixture was adjusted to pH 6.0 with a sodium hydroxide solution. Just prior to coating, 2.84 g of Dispersion-1, and 0.2 ml of HAR1 were added. The resulting formulation was coated at 88 g/m² onto a 0.178 mm gelatin-subbed clear poly(ethylene terephthalate) support. The resulting imaging coating had the following dry component coverage given in g/m²: 4.5 of gelatin, 1.52 of silver behenate-phthalazine complex compound, 0.56 of C-1, 0.35 g of M-1, and 1.65 of CDA-1. After drying and hardening the layer for 24 hours, the coated material was cut into 35 mm strips (samples) and processed in a thermal processor at 160° C. for 18 seconds. The sensitometric results are shown in TABLE I below.

The storage stability of the thermographic material of this invention was also evaluated in a humid environment. Samples of this example were stored either for 1 week, 49° C. and 50% relative humidity or for 24 hours, 21° C. and 80% relative humidity prior to thermal processing. The results of these tests are shown in TABLE II below.

### EXAMPLE 2 (INVENTION)

The thermographic material of this example was prepared similarly to that of Invention Example 1 except that an equal amount of DISP-2 was substituted for DISP-1. The color densities, both before and after processing, are shown in TABLE I provided below.

### EXAMPLE 3 (COMPARATIVE)

A thermographic film outside of the present invention was prepared similar to that in Invention Example 1 except that 0.6 g of BWDev and 2.24 g of water were substituted for Dispersion-1.

The imaging coating had the following dry component coverage given in g/m²: 4.0 of gelatin, 1.52 of silver behenate-phthalazine complex compound, 0.44 of C-1, 0.36 of M-1, and 0.48 of BSAP.

After drying and hardening the coated layer for 24 hours, the coating was cut into 35 mm strips (samples) and processed in a thermal processor at 160° C. for 18 seconds or at 122° C. for 15 seconds. The color densities, both before and after processing are shown in TABLE I below.

### EXAMPLE 4 (COMPARATIVE)

A thermographic material outside of this invention was prepared similarly to that of Invention Example 1 except that 0.3 g of BWDev and 2.54 g of water were substituted for Dispersion-1. The resulting imaging coating had the following component coverage given in g/m²: 4.0 of gelatin, 1.52 of silver behenate-phthalazinone complex compound, 0.44 of C-1, 0.36 of M-1, and 0.24 of BSAP. The color densities, both before and after processing, are shown in TABLE I provided below.

### EXAMPLE 5 (COMPARATIVE)

Another thermographic material outside of this invention was prepared in the following manner:

To 15.6 g of deionized water and 0.76 g of oxidized deionized bone gelatin at 40° C., was dissolved 0.06 of phthalazinone. Then, with stirring, 1.8 of DISP-1, 0.47 g of BWDev, and 0.15 ml of a 6.8 weight % SDS solution were added. The resulting mixture was adjusted to pH 6.0 with a sodium hydroxide solution. Just prior to coating, 0.1 ml of HAR1 was added. The resulting formulation was coated on a clear poly(ethylene terephthalate) support as described in Invention Example 1. The resulting imaging coating had the following component coverage given in g/m²: 3.5 of gelatin, 1.96 of silver behenate-phthalazinone complex compound, 0.28 of phthalazinone, and 0.40 of BSAP. Samples of the film were prepared and processed as described in Invention Example 1. The color densities, both before and after processing, are shown in TABLE I provided below.

### EXAMPLE 6 (COMPARATIVE)

Still another thermographic material outside the present invention was prepared similarly to that of Comparative Example 5 except that an equal amount of DISP-2 was substituted for DISP-1. The resulting imaging coating had the following coverage given in g/m²: 3.5 of gelatin, 1.96 of silver behenate, 0.28 of phthalazinone, and 0.40 of BSAP. The color densities, both before and after processing, are shown in TABLE I provided below.

### EXAMPLE 7 (INVENTION)

Another thermographic material of this invention was prepared similarly to that Invention Example 1 except that 5.08 g of Dispersion-3 was substituted for Dispersion-1. The resulting imaging coating had the following component coverage given in g/m²: 4.0 of gelatin, 1.52 of silver behenate-phthalazinone complex compound, 0.56 of C-1, 0.35 of M-1, 2.1 of CDA-3. The color densities, both before and after processing, are shown in TABLE I provided below.

### EXAMPLE 8 (COMPARATIVE)

Another thermographic material outside the scope of this invention was prepared similarly to that Invention Example 1 except that 0.84 g of DISP-1 and 0.11 g of KODAK Color Developing Agent CD-3 were dissolved in 7.8 g of water instead of Dispersion-1. The color densities, both before and after processing, are shown in TABLE I provided below.

### EXAMPLE 9 (COMPARATIVE)

Another thermographic material outside the scope of this invention was prepared as follows:

To 12.4 g of deionized water was added, with stirring at 40° C., 0.66 g of oxidized deionized bone gelatin, 1.47 of DISP-1, 2.26 g of Cyan-1 Coupler Dispersion, 1.18 g of Magenta-1 Coupler Dispersion, and 0.15 ml of a 6.8 weight % SDS solution. The resulting mixture was adjusted to pH 5.0 with nitric acid. Just prior to coating, 0.022 g of KODAK Color Developing Agent CD-2 dissolved in 1.25 g of water and 0.2 ml of HAR1 were added. The resulting formulation was coated on a clear poly(ethylene terephthalate) support as described in Invention Example 1. The resulting imaging coating had the following component coverage given in g/m²: 4.0 of gelatin, 1.55 of silver behenate-phthalazinone complex compound, 0.51 of C-1, 0.36 of M-1, and 0.099 of KODAK Color Developing Agent CD-2. Samples of the film were prepared and processed as described in Invention Example 1. The color densities, both before and after processing, are shown in TABLE I provided below.

TABLE I

| | Developing | DISP-1 or | Densities before | Densities after | |
|---|---|---|---|---|---|
| | Agent (g/m²) | DISP-2 | Processing | Processing | Average Density after |
| Example | {mmol/m²} | (g/m²) | Red, Green, Blue | Red, Green, Blue | Processing and (spread) |
| Invention | CDA-1 (1.65) | DISP-1 | 0.03, 0.04, 0.05 | 3.24, 2.92, 3.28 | 3.15 (0.36) |
| Example 1 | {2.6} | (1.52) | | | |
| Invention | CDA-1 (1.65) | DISP-2 | 0.03, 0.04, 0.06 | 3.21, 2.82, 2.88 | 2.97 (0.39) |
| Example 2 | {2.6} | (1.52) | | | |
| Comparative | BSAP (0.48) | DISP-1 | 0.02, 0.03, 0.04 | 0.21, 0.66, 2.69 | 1.19 (2.48) |
| Example 3 | {1.95} | (1.52) | | | |
| Comparative | BSAP (0.24) | DISP-1 | 0.02, 0.03, 0.04 | 0.16, 0.44, 1.72 | 0.77 (1.56) |
| Example 4 | {0.97} | (1.52) | | | |
| Comparative | BSAP (0.40) | DISP-1 | 0.03, 0.03, 0.04 | 1.18, 1.79, 2.63 | 1.87 (1.45) |
| Example 5 | {1.6} | (1.96) | | | |
| Comparative | BSAP (0.40) | DISP-2 | 0.03, 0.04, 0.05 | 1.26, 1.79, 2.11 | 1.72 (0.85) |
| Example 6 | {1.6} | (1.96) | | | |
| Invention | CDA-3 (2.1) | DISP-1 | 0.04, 0.04, 0.06 | 2.94, 3.20, 2.92 | 3.02 (0.28) |
| Example 7 | {5.2} | (1.52) | | | |
| Comparative | CD-3 (0.48) | DISP-1 | 0.35, 0.27, 0.20 | 1.99, 1.60, 1.54 | 1.71 (0.45) |
| Example 8 | {1.1} | (0.87) | | | |
| Comparative | CD-2 (0.099) | DISP-1 | 1.37, 0.41, 0.26 | 2.49, 0.54, 0.71 | 1.25 (1.95) |
| Example 9 | {0.46} | (1.55) | | | |

The results given in Table I show that all of the comparative film samples produced an image that had a much higher blue density than red or green densities. This caused the resulting images to have a strong yellow tint. The materials of this invention (Invention Examples) provided images closer to neutral density image after processing (small spread) compared to the materials outside of the present invention (Comparatives Examples). Thus, the materials of the present invention provided greater control of the tone (image tint) of the processed images and resulted in more neutral black-and-white images upon processing. It should be noted that Comparison Examples 5 and 6 contained phthalazinone as a toner to reduce the yellow tone, but it did not eliminate it. It should also be noted that thermographic systems are often coated on blue-base supports that helps mask some yellow tone of the silver image.

Comparative Examples 8 and 9 illustrate the instability of the film samples when conventional non-blocked color developing agents are used in place of blocked color developing agents. The densities before processing shown in Table I were significantly higher than the Invention Examples. Overall image densities in the Comparative materials were low.

The data in TABLE I also show that a significantly higher average density is obtained for the materials of this invention compared to the Comparative Examples containing equal (and less) silver behenate because processing of the Invention materials gave both silver metal (yellow image) and dye (cyan and magenta dyes) to give a neutral image from the same color developing chemistry.

TABLE II

| | Densities before | Densities |
|---|---|---|
| | Processing | after Processing |
| Test | Red, Green, Blue | Red, Green, Blue |
| Freshly Coated | 0.03, 0.04, 0.05 | 3.24, 2.92, 3.28 |
| 1 week, 49° C., 50% RH | 0.16, 0.08, 0.18 | 3.15, 2.72, 3.25 |
| 24 hours, 21° C., 80% RH | 0.04, 0.06, 0.07 | 3.29, 2.77, 3.09 |

The results in TABLE II show that the material of this invention exhibited moderately good raw stock incubation stability. The Example 1 material showed only a modest density increase before processing and only a small density decrease after processing for two different incubation conditions when compared to the freshly coated sample.

### EXAMPLE 10 (INVENTION)

A thermographic material of this invention was prepared similarly to that of Invention Example 1 except that the imaging layer formulation was; scaled up and coated to provide 8×10 inch (20.3×25.4 cm) film sheets. A film sheet was processed in a commercially available AGFA DRYSTAR 2000 resistive thermal head imaging processor to provide an acceptable image of the test pattern.

The invention has been described in detail with particular reference to certain preferred embodiments thereof, but it will be understood that variations and modifications can be effected within the spirit and scope of the invention.

1. A black-and-white thermographic material comprising a support having thereon at least one imaging layer comprising a binder and imaging chemistry that consists essentially of:
a) a non-photosensitive source of reducible silver ions,
b) a color developing agent precursor that releases a color developing agent when heated to a temperature of at least 80° C.,
c) a cyan dye-forming color coupler that is capable of reacting with said released color developing agent to produce a cyan dye, and
d) a magenta dye-forming color coupler that is capable of reacting with said released color developing agent to produce a magenta dye,
wherein said released color developing agent is further capable of reducing said reducible silver ions.

2. The material of claim 1 that is substantially free of black-and-white developing agents that are capable of solely reducing said reducible silver ions.

3. The material of claim 1 that is substantially free of phthalazinone and phthalazinone derivatives.

4. The material of claim 1 wherein said color developing agent precursor releases ap-phenylenediamine color developing agent upon heating to a temperature of at least 80° C.

5. The material of claim 1 wherein said non-photosensitive source of reducible silver ions is provided as a nanoparticulate dispersion.

6. The material of claim 1 wherein said non-photosensitive source of reducible silver ions includes one or more silver carboxylates, one of which is silver behenate.

7. The material of claim 6 wherein said non-photosensitive source of reducible silver ions includes highly crystalline silver behenate.

8. The material of claim 1 wherein said color developing agent precursor is present in an amount of from about 0.01 to about 2 mol per mole of total silver.

9. The material of claim 1 wherein said cyan dye-forming color coupler and said magenta dye-forming color coupler are independently present in an amount of from 0.05 to 2 mol per mole of reducible silver ions.

10. The material of claim 1 wherein said cyan dye-forming color coupler and said magenta dye-forming color coupler are independently present in an amount of from 0.10 to 1 mol per mole of reducible silver ions.

11. The material of claim 1 wherein the amount of total silver is at least 0.001 mol/m².

12. The material of claim 1 wherein said binder is a hydrophilic binder or a water-dispersible polymer latex binder.

13. The material of claim 1 further containing a toning agent that is a phthalazine or phthalazine derivative, that is present in an amount of from about 0.01 to about 10% based on the total dry weight of the layer in which it is located.

14. The material of claim 1 that is duplitized, having one or more of the same or different imaging layers on both sides of said support.

15. The material of claim 1 further comprising a protective layer over said one or more imaging layers.

16. A black-and-white, non-photosensitive thermographic material that comprises a transparent polymer support having on only one side thereof one or more thermally sensitive imaging layers and an outermost non-thermally sensitive protective layer over said one or more thermally sensitive imaging layers,
said one or more thermally sensitive imaging layers comprising one or more hydrophilic binders, and in reactive association, imaging chemistry consisting essentially of:
a) a non-photosensitive source of reducible silver ions that includes one or more silver aliphatic carboxylates at least one of which is silver behenate,
b) a color developing agent precursor that releases a p-phenylenediamine color developing agent when heated to a temperature of at least 80° C.,
c) a development enhancing toning agent,
d) a cyan dye-forming color coupler that is capable of reacting with said released color developing agent to produce a cyan dye, and
e) a magenta dye-forming color coupler that is capable of reacting with said released color developing agent to produce a magenta dye,
said cyan dye-forming color coupler and magenta dye-forming color coupler being independently present in an amount from 0.1 to 1 mole per mole of reducible silver ions, and the amount of silver is at least 0.001 mol/m², and wherein said released color developing agent is further capable of reducing said reducible silver ions and said material is substantially free of black-and-white developing agents that are capable of solely reducing said reducible silver ions and substantially free of phthalazinone and phthalazinone derivatives.

17. The material of claim 16 wherein said hydrophilic binder is gelatin or a derivative thereof, a cellulosic material, or a poly(vinyl alcohol).

18. The material of claim 15 wherein said color developing agent precursor is present in an amount of from about 0.01 to about 2 mol per mole of total silver, and said toning agent is a phthalazine or phthalazine derivative that is present in an amount of from about 0.01 to about 10% based on the total dry weight of the layer in which it is located.

19. A method comprising imaging the thermographic material of claim 1 with a thermal imaging source to provide a visible image.

20. The method of claim 19 wherein said thermographic material comprises a transparent support and said image-forming method further comprises:
positioning said imaged thermographic material with the visible image thereon between a source of imaging radiation and an imageable material that is sensitive to said imaging radiation, and
thereafter exposing said imageable material to said imaging radiation through the visible image in said imaged thermographic material to provide an image in said imageable material.

21. A method comprising imaging the thermographic material of claim 16 with a thermal imaging source to provide a visible image.

22. The method of claim 19 wherein said imaging is carried out using a thermal print head or a laser.

23. The method of claim 19 further comprising using said imaged thermographic material for medical diagnostic purposes.
